(19) United States
(12) Patent Application Publication
(10) Pub. No.: US 2015/0220642 A1
(43) Pub. Date: Aug. 6, 2015

(54) METHOD, SYSTEM, AND DEVICE FOR OBTAINING CONTACT INFORMATION

(71) Applicant: Xiaomi Inc., Beijing (CN)

(72) Inventors: Tao PENG, Beijing (CN); Xinyu LIU, Beijing (CN); Wenlin WANG, Beijing (CN); Jun LEI, Beijing (CN); Feng HONG, Beijing (CN)

(73) Assignee: Xiaomi Inc.

(21) Appl. No.: 14/128,968

(22) Filed: Dec. 23, 2013

Related U.S. Application Data
(63) Continuation of application No. PCT/CN2013/078882, filed on Jul. 5, 2013.

(30) Foreign Application Priority Data
Sep. 3, 2012 (CN) 201210322558.2

(51) Int. Cl. G06F 17/30; G06F 3/0484; H04M 1/27

(52) U.S. Cl. CPC G06F 17/30867; H04M 1/271; G06F 3/04842

(57) ABSTRACT

A method for obtaining contact information includes obtaining a contact name entered by a user through a dialing interface and searching a local database according to the contact name to determine whether basic contact information corresponding to the contact name is stored in the local database. If stored, the basic contact information stored in the local database is obtained. If the basic contact information is not stored in the local database, searching a database server on a network is performed to determine whether the basic contact information is stored in the database server, the basic contact information is obtained from the database server when the basic contact information is stored in the database server, and the obtained basic contact information is stored in the local database. The method also includes establishing a communication connection with a contact corresponding to the contact name by using the obtained basic contact information.

### CROSS-REFERENCE TO RELATED APPLICATIONS

This application is a Continuation of Application No. PCT/CN2013/078863, filed on Jul. 5, 2013, which claims priority to Chinese Patent Application No. 201210322558.2, filed on Sep. 3, 2012, the entire contents of both of which are incorporated herein by reference.

### TECHNICAL FIELD

The disclosure relates to the technical field of communication and, more particularly, to a method, system, and device for obtaining contact information.

### BACKGROUND

Currently, when a user wishes to select a number of a contact using a mobile terminal to perform a dialing connection, generally an application program other than the dialing interface needs to be started on the mobile terminal. The user can then search a database storing contact information and obtain desired contact information via the application program. For example, when the user wishes to dial a number using the mobile terminal, the user needs to start a telephone book program and locate the desired contact information in the telephone book.

With conventional technology, searching contact information on a mobile terminal requires an application program other than a dialing program, which is relatively inconvenient and requires more system resources. Moreover, an automatic search matching cannot be realized. Further, with the conventional technology, matching of contact information can only be performed on the mobile terminal, but a larger scope of matching with more contact information cannot be realized. Therefore, the conventional technology cannot meet the present demand for searching and matching more contact information, such as automatically obtaining contact information provided in a network, or booking hotel rooms or tickets.

Moreover, when the user finishes a communication with an unknown contact, information of the unknown contact cannot be recorded and stored automatically.

With the conventional contact information searching and obtaining methods, every time a search is performed, search conditions, such as a contact name, needs to be input completely and accurately to realize an accurate matching search. This input method is inconvenient when a mobile terminal with a small screen is used. Especially for users inexperienced with the operation of a mobile terminal, it is difficult to achieve an accurate, timely, and reliable search for contact information.

### SUMMARY

In accordance with embodiments of the disclosure, there is provided a method for obtaining contact information. The method includes obtaining a contact name entered by a user through a dialing interface and searching a local database according to the contact name to determine whether basic contact information corresponding to the contact name is stored in the local database. If stored, the basic contact information stored in the local database is obtained. If the basic contact information is not stored in the local database, searching a database server on a network is performed to determine whether the basic contact information is stored in the database server, the basic contact information is obtained from the database server when the basic contact information is stored in the database server, and the obtained basic contact information is stored in the local database. The method also includes establishing a communication connection with a contact corresponding to the contact name by using the obtained basic contact information.

Also in accordance with embodiments of the disclosure, there is provided a device for obtaining contact information. The device includes an obtaining module configured to obtain a contact name entered by a user through a dialing interface, a search module configured to search a local database according to the contact name to determine whether basic contact information corresponding to the contact name is stored in the local database. If stored, the search module obtains the basic contact information stored in the local database. If the basic contact information is not stored in the local database, the search module searches a database server on a network to determine whether the basic contact information is stored in the database server. When the basic contact information is stored in the database server, the search module obtains the basic contact information from the database server, and stores the obtained basic contact information in the local database. The device further includes a communication module configured to establish a communication connection with a contact corresponding to the contact name by using the obtained basic contact information.

Also in accordance with embodiments of the disclosure, there is provided a database server. The database server includes a receiving module and a supplying module. The receiving module is configured to receive a request from a terminal device for obtaining basic contact information corresponding to a contact name entered through a dialing interface on the terminal device. The supplying module is configured to provide the basic contact information stored in the database server to the terminal device.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is an illustrative flowchart showing a method for obtaining contact information according to an embodiment.

FIG. 2 is an illustrative flowchart showing a method for obtaining contact information according to an embodiment.

FIG. 3 is an illustrative flowchart showing a method for obtaining contact information according to an embodiment.

FIG. 4 schematically shows a system for obtaining contact information according to an embodiment.

FIG. 5 schematically shows a terminal device according to an embodiment.

FIG. 6 schematically shows a device for obtaining contact information according to an embodiment.

FIG. 7 schematically shows a database server according to an embodiment.

### DETAILED DESCRIPTION

Embodiments consistent with the disclosure include a method, system, and device for obtaining contact information.

Hereinafter, embodiments consistent with the disclosure will be described with reference to the drawings. Wherever possible, the same reference numbers will be used throughout the drawings to refer to the same or like parts.

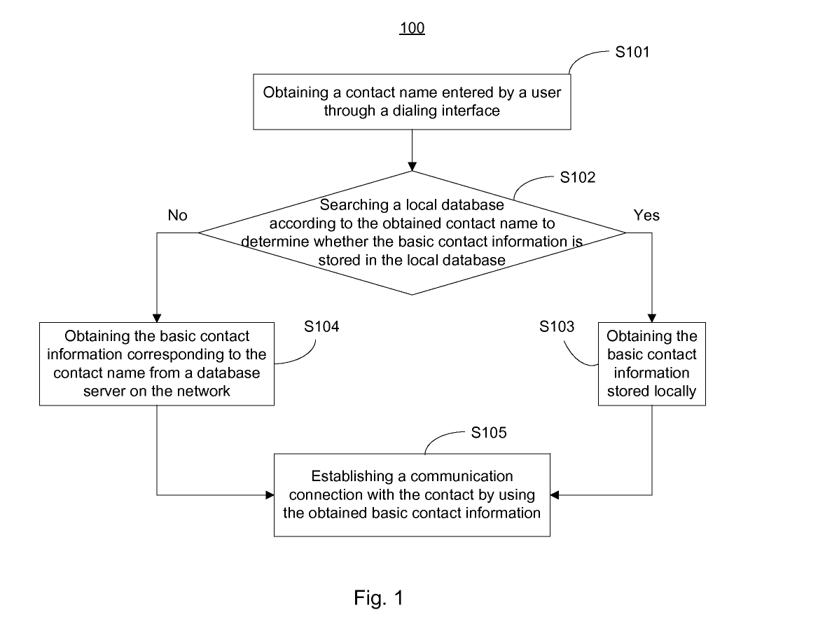

FIG. 1 is a flowchart showing an exemplary method 100 for obtaining contact information consistent with embodiments of the disclosure. The method shown in FIG. 1 includes searching a network database and a local database through a dialing program to realize a contact search having a large scope.

As shown in FIG. 1, at S101, a contact name entered by a user through a dialing interface is acquired. For example, the user may enter a character string using a T9 keyboard provided by the dialing interface. At least one piece of matched input information corresponding to the input character string is obtained through automatic matching. The user can select one piece of input information from the at least one piece of candidate information as a contact name. As used herein, T9 technology refers to a technology for inputting characters using number keys on a telephone keyboard, which can then be further used to search Chinese words.

The user uses the T9 keyboard to input a target name on the dialing interface, so as to realize a search for more detailed information. When the user needs to communicate with a contact, the user presses corresponding keys on the T9 keyboard, which could be matched keywords or numbers. Since T9 allows inputting either numbers or letters, the input numbers or letters can both be matched to data corresponding to the numbers or letters on the keys. For example, the user may use the T9 keyboard to enter 9 (X), 5 (L), 43 (Ge), and a contact name “Xi Li Ge” matching this input would be located. Alternatively, the user may enter 9 (X), 54 (Li), 4 (G), and the contact name “Xi Li Ge” would be located. As another example, when the user selects a phone number of a hotel, a corresponding name of the hotel will be automatically located in a database.

At S102, the local database is searched according to the obtained contact name, to find whether basic contact information of the contact is stored in the local database. If yes, S103 is performed. Otherwise, S104 is performed.

The mobile terminal stores the contact information in the local database as a backup database of the network database. The contact information stored in the network database may be imported into and stored in the local database as a backup. When the user needs to communicate with a contact, the local database is searched first to determine whether there is data matching with the contact, i.e., the contact information. If the contact information is not found in the local database, the network database is searched. The network database may be stored on various database servers on the network, such as, for example, the network server for ctrip.com.

The basic contact information may include, for example, a contact name, a wireless network communication number (such as a mobile phone number), and/or a landline phone number.

At S103, the basic contact information stored locally is obtained. Then S105 is performed.

When the contact information to be obtained is stored in the local database, the contact information is obtained directly from the local server. Such a method for obtaining contact information by matching the contact name directly with information entered using the T9 keyboard does not need to start other application programs except the dialing program. As a consequence, the operation process is simplified and the consumption of system resources is reduced.

At S104, the basic contact information corresponding to the contact name is obtained from a database server on the network.

When the contact information to be obtained is not found in the local database, it can be obtained from the database server on the network. For example, various contact information, including the contact information for, e.g., hotel room booking or ticket booking, is provided by and can be obtained from the database servers of various websites. As such, more contact information can be obtained, and a larger scope of information search can be realized. When searching the contact information on the network, the user may narrow the search scope by performing an accurate search using, e.g., location information.

In some embodiments, the obtained basic contact information may be stored in the local database. Thus, when the contact information is searched again, it may be directly obtained from the local database rather than from the network database. Accordingly, the amount of network information being transmitted and the consumed network resources are reduced.

At S105, a communication connection with the contact is established by using the obtained basic contact information.

After obtaining the contact information, for example, the landline phone number or the mobile terminal number of the contact, the user may perform dialing directly to realize the communication connection.

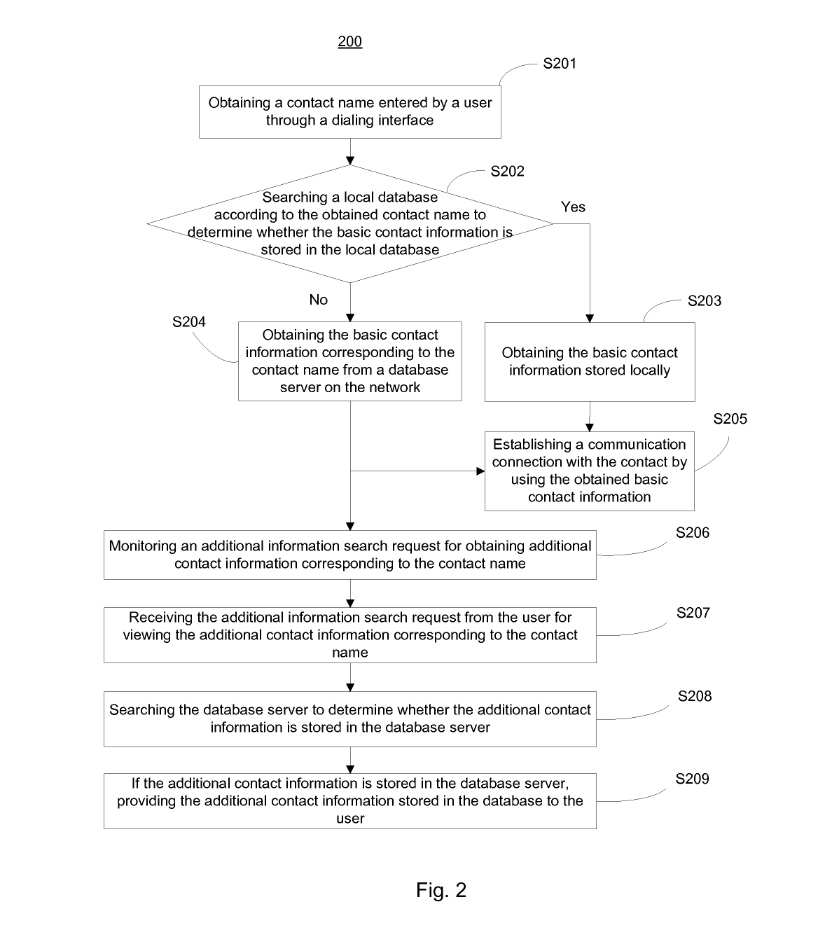

FIG. 2 is a flowchart showing an exemplary method 200 for obtaining contact information consistent with embodiments of the disclosure. Specifically, FIG. 2 shows a process for searching the network database and the local database through the dialing program to realize a large scope contact search.

As shown in FIG. 2, at S201, a contact name entered by a user through a dialing interface is acquired. Details of S201 are similar to those of S101, and thus are not repeated.

At S202, the local database is searched according to the obtained contact name, to find whether basic contact information of the contact is stored in the local database. If yes, S203 is performed. Otherwise, S204 is performed. Details of S202 are similar to those of S102, and thus are not repeated.

At S203, the basic contact information stored locally is obtained. Then S205 is performed. Details of S203 are similar to those of S103, and thus are not repeated.

At S204, the basic contact information corresponding to the contact name is obtained from a database server on the network. Then S205 and S206 are performed. Details of S204 are similar to those of S104, and thus are not repeated.

At S205, a communication connection with the contact is established by using the obtained basic contact information. Details of S205 are similar to those of S105, and thus are not repeated.

At S206, whether an additional information search request is made by the user for obtaining additional contact information corresponding to the contact name is monitored.

After the basic contact information corresponding to the contact name is obtained from the database server on the network, it is further determined whether the user also needs to obtain the additional contact information.

The additional contact information may include at least one of detailed description information about the contact, address and postal code of the contact, contact assessment information, or pictures, email addresses, or instant communication numbers corresponding to the contact.

At S207, the additional information search request is received from the user for viewing the additional contact information corresponding to the contact name.

At S208, the database server is searched to determine whether the additional contact information corresponding to the contact name is stored in the database server.

After the basic contact information corresponding to the contact name is obtained from the database server on the network, if an additional information search request is received from the user for viewing the additional contact information corresponding to the contact name, i.e., if the user needs to obtain the additional contact information corresponding to the contact name, the database server is searched to determine whether the additional contact information corresponding to the contact name is stored in the database server.

At S209, if it is found that the additional contact information corresponding to the contact name is stored in the database server, the additional contact information corresponding to the contact name that is stored in the database server is provided to the user.

In some embodiments, the terminal device may store the obtained additional contact information in the local database.

When providing the contact information and the additional contact information to the user, the information to be displayed and the display mode may be set and defined by the server, which may be displayed in a User Interface (UI) on the terminal device.

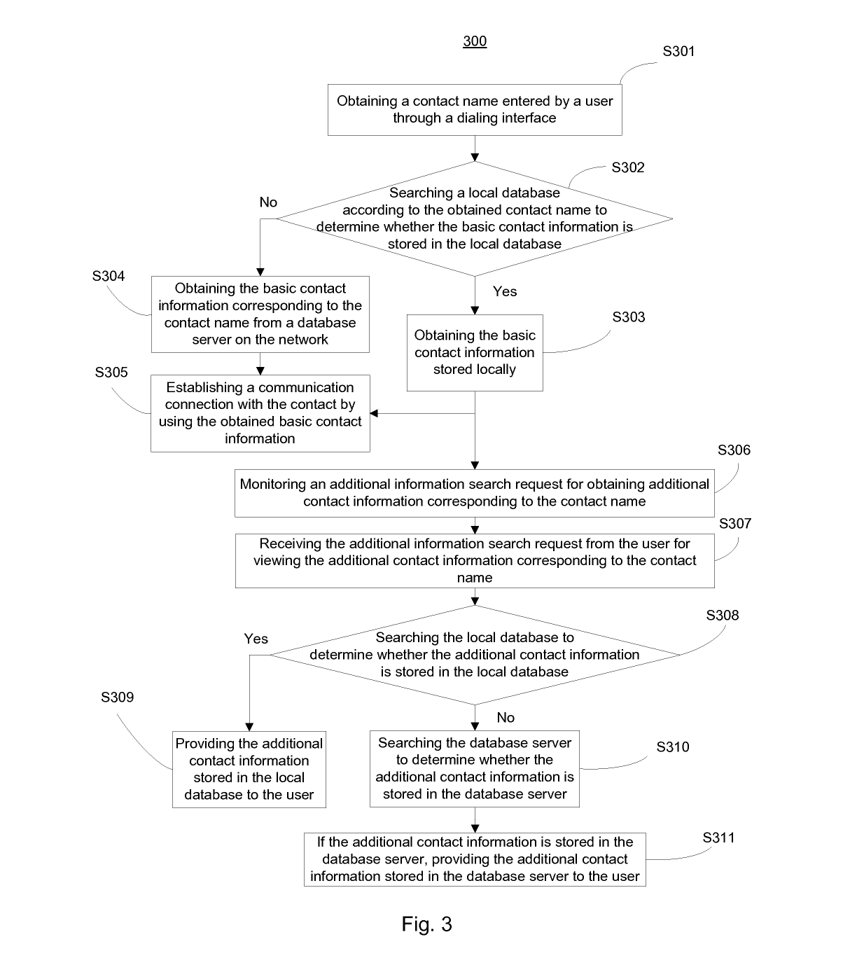

FIG. 3 is a flowchart showing an exemplary method 300 for obtaining contact information consistent with embodiments of the disclosure. Specifically, FIG. 3 shows a process for searching the network database and the local database through the dialing program to realize a large scope contact search.

At S301, a contact name entered by a user through a dialing interface is acquired. Details of S301 are similar to those of S101, and thus are not repeated.

At S302, the local database is searched according to the obtained contact name, to find whether the basic contact information is stored in the local database. If yes, S303 is performed. Otherwise, S304 is performed. Details of S302 are similar to those of S102, and thus are not repeated.

At S303, the basic contact information stored in the local database is obtained. Then S305 and S306 are performed.

At S304, the basic contact information corresponding to the contact name is obtained from a database server on the network. Then S305 is performed. Details of S304 are similar to those of S104, and thus are not repeated.

At S305, a communication connection with the contact is established by using the obtained basic contact information. Details of S305 are similar to those of S105, and thus are not repeated.

At S306, whether an additional information search request is made by the user for obtaining additional contact information corresponding to the contact name is monitored.

After the basic contact information corresponding to the contact name is obtained from the local database, it is further determined whether the user also needs to obtain the additional contact information.

At S307, the additional information search request is received from the user for viewing the additional contact information corresponding to the contact name.

At S308, the local database is searched to determine whether the additional contact information corresponding to the contact name is stored in the local database. If yes, S309 is performed. Otherwise, S310 is performed.

After obtaining the basic contact information stored locally, if an additional information search request is received from the user for viewing the additional contact information corresponding to the contact name, i.e., if the user needs to obtain the additional contact information corresponding to the contact name, the local database is searched first to determine whether the additional contact information corresponding to the contact name is stored in the local database.

At S309, if it is found that the additional contact information corresponding to the contact name is stored in the local database, the additional contact information stored in the local database is provided to the user.

At S310, the database server is searched to determine whether the additional contact information corresponding to the contact name is stored in the database server.

When the additional contact information corresponding to the contact name is not found in the local database, the database server is searched at S310 to determine whether the additional contact information corresponding to the contact name is stored in the database server.

At S311, if it is found that the additional contact information corresponding to the contact name is stored in the database server, the additional contact information stored in the database server is provided to the user.

In some embodiments, the terminal device may store the obtained additional contact information in the local database.

In some embodiments, if the basic contact information corresponding to the contact name cannot be obtained from either the local database or the database server, the basic contact information entered by the user through the dialing interface is obtained, and then stored in the local database. After the user dials using the dialing interface, the dialed number and the contact name may be stored as a temporary contact, which may then be stored in the local database after the user confirms.

In some embodiments, the terminal may connect to a selected database server according to a predetermined update cycle, and update the contact information in the local database according to the contact information stored in the database server. In other words, the local database may be dynamically updated according to the network database. For this purpose, a connection between the network side database and the local database is established. After a network communication is obtained, the data in the local database may be automatically updated and stored. The update timing or update cycle may be pre-set.

Consistent with embodiments of the disclosure, the contact information may be obtained from the local database, or may be obtained online directly from the network database. The local database may be updated according to the network database. Meanwhile, when contact information data that is rarely used is detected, it may be deleted to release storage space. For example, data that is not accessed for longer than a pre-set time would be deleted. Data meeting the deleting condition may be deleted directly, or be deleted after the user confirms.

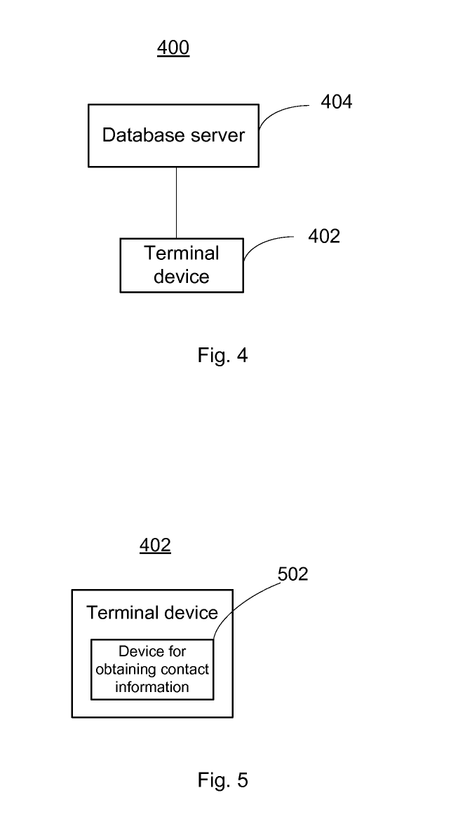

FIG. 4 schematically shows an exemplary system 400 for obtaining contact information consistent with embodiments of the disclosure. The system 400 includes a terminal device 402 and a database server 404 on a network. In some embodiments, the system 400 may include multiple terminal devices 402.

The terminal device 402 is configured to obtain a contact name entered by a user through a dialing interface and to search a local database according to the obtained contact name, to find whether the basic contact information is stored in the local database. The terminal device 402 is further configured to, if the basic contact information is stored in the local database, obtain the basic contact information stored locally, and to, if the basic contact information is not stored in the local database, obtain the basic contact information corresponding to the contact name from the database server 404. The terminal device 402 is also configured to store the obtained basic contact information in the local database, and to establish a communication connection with the contact by using the obtained basic contact information.

The database server 404 is configured to receive a request from the terminal device 402 for obtaining the basic contact information corresponding to the contact name entered through the dialing interface, and to provide the basic contact information stored in the database server 404 to the terminal device 402.

In some embodiments, the terminal device 402 is configured to acquire a character string entered through a T9 keyboard provided by the dialing interface, to provide at least one piece of matched input information corresponding to the input character string, and to receive a selection by the user of one piece of input information from the at least one matched input information as a contact name.

In some embodiments, after the basic contact information stored locally is obtained, if an additional information search request is received from the user for viewing additional contact information corresponding to the contact name, the terminal device 402 further searches the local database to determine whether the additional contact information corresponding to the contact name is stored in the local database. If the additional contact information corresponding to the contact name is stored in the local database, the terminal device 402 provides the additional contact information corresponding to the contact name to the user.

In some embodiments, if the additional contact information corresponding to the contact name is not found in the local database, the terminal device 402 searches the database server 404 to determine whether the additional contact information is stored in the database server 404. If the additional contact information corresponding to the contact name is stored in the database server 404, the terminal device 402 provides the additional contact information corresponding to the contact name to the user and stores the obtained additional contact information in the local database.

In some embodiments, after the basic contact information corresponding to the contact name from the database server 404 is received, if an additional information search request is received from the user for viewing the additional contact information corresponding to the contact name, the terminal device 402 searches the database server 404 to determine whether the additional contact information is stored in the database server 404. If the additional contact information corresponding to the contact name is stored in the database server 404, the terminal device 402 provides the additional contact information corresponding to the contact name to the user and stores the obtained additional contact information in the local database.

In some embodiments, if the basic contact information corresponding to the contact name cannot be located either in the local database or in the database server 404, the terminal device 402 acquires the basic contact information entered by the user through the dialing interface, and stores the obtained basic contact information in the local database.

In some embodiments, the terminal device 402 is also configured to connect to the database server 404 according to a predetermined update cycle, and update the contact information in the local database according to the contact information stored in the database server 404.

In some embodiments, the database server 404 is also configured to receive a request from the terminal device 402 for obtaining the additional contact information corresponding to the contact name, and to provide the additional contact information corresponding to the contact name stored in the database server 404 to the terminal device 402.

In some embodiments, the database server 404 is also configured to receive a request from the terminal device 402 for updating the contact information in the local database of the terminal device 402, and to update the contact information in the local database of the terminal device 402 according to the contact information stored in the database server 404.

FIG. 5 schematically shows an exemplary structure of the terminal device 402. As shown in FIG. 5, the terminal device 402 includes a device for obtaining contact information 502.

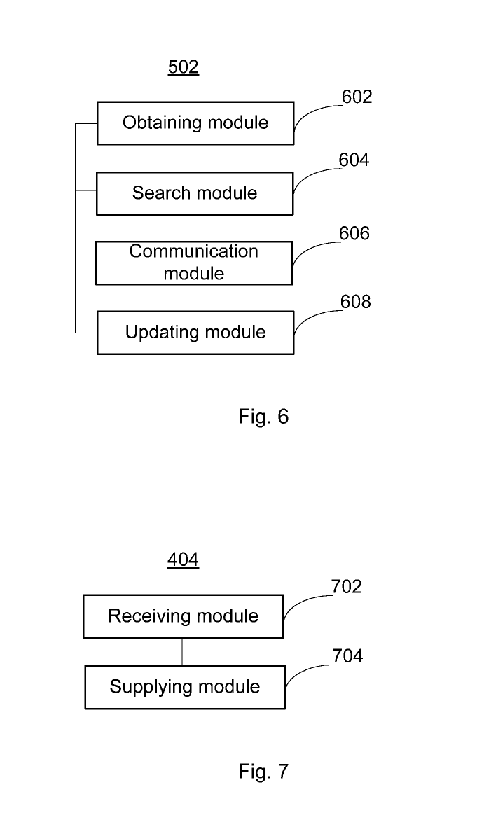

FIG. 6 schematically shows an exemplary structure of the device for obtaining contact information 502. As shown in FIG. 6, the device for obtaining contact information 502 includes an obtaining module 602, a search module 604, and a communication module 606.

The obtaining module 602 is configured to obtain a contact name entered by a user through a dialing interface.

The search module 604 is configured to search a local database according to the contact name, to find whether the basic contact information of the contact is stored in the local database. If the basic contact information of the contact is stored in the local database, the search module 604 obtains the basic contact information stored locally. If the basic contact information of the contact is not stored in the local database, the search module 604 obtains the basic contact information corresponding to the contact name from the database server 404, and stores the obtained basic contact information in the local database.

The communication module 606 is configured to establish a communication connection with the contact by using the obtained basic contact information.

In some embodiments, the obtaining module 602 is configured to acquire a character string entered through a T9 keyboard provided by the dialing interface, to provide at least one piece of matched input information corresponding to the input character string, and to receive a selection by the user of one piece of input information from the at least one matched input information as a contact name.

In some embodiments, after the basic contact information stored locally is obtained, if an additional information search request is received from the user for viewing additional contact information corresponding to the contact name, the searching module 604 searches the local database to determine whether the additional contact information corresponding to the contact name is stored in the local database. If the additional contact information corresponding to the contact name is stored in the local database, the searching module 604 provides the additional contact information corresponding to the contact name to the user.

In some embodiments, if the additional contact information corresponding to the contact name is not found in the local database, the search module 604 searches the database server 404 to determine whether the additional contact information is stored in the database server 404. If the additional contact information corresponding to the contact name is stored in the database server 404, the search module 604 provides the additional contact information corresponding to the contact name to the user and stores the obtained additional contact information in the local database.

In some embodiments, after the basic contact information corresponding to the contact name from the database server 404 is received, if an additional information search request is received from the user for viewing the additional contact information corresponding to the contact name, the search module 604 searches the database server 404 to determine whether the additional contact information is stored in the database server 404. If the additional contact information corresponding to the contact name is stored in the database server 404, the search module 604 provides the additional contact information corresponding to the contact name to the user and stores the obtained additional contact information in the local database.

In some embodiments, if the basic contact information corresponding to the contact name cannot be located either in the local database or in the database server 404, the search module 604 acquires the basic contact information entered by the user through the dialing interface, and stores the obtained basic contact information in the local database.

As shown in FIG. 6, the device for obtaining contact information 502 further includes an updating module 608 configured to connect with the database server 404 according to a predetermined update cycle, and to update the contact information in the local database according to the contact information stored in the database server 404.

FIG. 7 schematically shows an exemplary structure of the database server 404. As shown in FIG. 7, the database server 404 includes a receiving module 702 and a supplying module 704.

The receiving module 702 is configured to receive a request from the terminal device 402 for obtaining the basic contact information corresponding to the contact name entered through the dialing interface.

The supplying module 704 is configured to provide the basic contact information stored in the database server 404 to the terminal device 402.

In some embodiments, the receiving module 702 is also configured to receive a request from the terminal device 402 for obtaining the additional contact information corresponding to the contact name. The supplying module 704 is also configured to provide the additional contact information stored in the database server 404 to the terminal device 402.

In some embodiments, the receiving module 702 is also configured to receive a request from the terminal device 402 for updating the contact information in the local database of the terminal device 402. The supplying module 704 is also configured to update the contact information in the local database of the terminal device 402 according to the contact information stored in the database server 404.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for obtaining contact information, comprising:
obtaining a contact name entered by a user through a dialing interface;
searching a local database according to the contact name to determine whether basic contact information corresponding to the contact name is stored in the local database,
if stored, obtaining the basic contact information stored in the local database;
if not stored:
searching a database server on a network to determine whether the basic contact information is stored in the database server;
obtaining, when the basic contact information is stored in the database server, the basic contact information from the database server; and
storing the obtained basic contact information in the local database; and
establishing a communication connection with a contact corresponding to the contact name by using the obtained basic contact information.

2. The method according to claim 1, wherein obtaining the contact name entered by the user through the dialing interface comprises:
acquiring a character string entered through a T9 keyboard provided by the dialing interface;
obtaining, through an automatic matching, at least one piece of matched input information according to the character string; and
receiving a selection by the user of one piece of input information from the at least one matched input information as the contact name.

3. The method according to claim 1, wherein, after obtaining the basic contact information stored in the local database, the method further comprises:
receiving an additional information search request from the user for viewing additional contact information corresponding to the contact name;
searching the local database to determine whether the additional contact information is stored in the local database; and
providing, when the additional contact information is stored in the local database, the additional contact information to the user.

4. The method according to claim 3, further comprising:
searching, if the additional contact information is not found in the local database, the database server to determine whether the additional contact information is stored in the database server; and
when the additional contact information is stored in the database server:
providing the additional contact information to the user; and
storing the obtained additional contact information in the local database.

5. The method according to claim 3, wherein:
obtaining the basic contact information includes obtaining at least one of the contact name, a wireless network communication number, or a landline phone number, and
providing the additional contact information includes providing at least one of detailed description information about the contact, an address or postal code of the contact, contact assessment information, or a picture, an email address, or an instant communication number corresponding to the contact.

6. The method according to claim 1, wherein, after obtaining the basic contact information from the database server on the network, the method further comprises:
receiving an additional information search request from the user for viewing additional contact information corresponding to the contact name;
searching the database server to determine whether the additional contact information is stored in the database server; and
when the additional contact information is stored in the database server:
providing the additional contact information to the user; and
storing the obtained additional contact information in the local database.

7. The method according to claim 1, wherein when the basic contact information is not stored in either the local database or the database server, the method further comprises:
obtaining the basic contact information entered by the user through the dialing interface; and
storing the obtained basic contact information in the local database.

8. The method according to claim 1, further comprising:
connecting to the database server according to a predetermined update cycle; and
updating contact information in the local database according to contact information stored in the database server.

9. A device for obtaining contact information, comprising:
an obtaining module, configured to obtain a contact name entered by a user through a dialing interface;
a search module, configured to:
search a local database according to the contact name to determine whether basic contact information corresponding to the contact name is stored in the local database;
if stored, obtain the basic contact information stored in the local database; and
if not stored:
search a database server on a network to determine whether the basic contact information is stored in the database server;
obtain, when the basic contact information is stored in the database server, the basic contact information from the database server; and
store the obtained basic contact information in the local database; and
a communication module, configured to establish a communication connection with a contact corresponding to the contact name by using the obtained basic contact information.

10. The device according to claim 9, wherein the obtaining module is further configured to:
acquire a character string entered through a T9 keyboard provided by the dialing interface;
obtain, through an automatic matching, at least one piece of matched input information according to the character string; and
receive a selection by the user of one piece of input information from the at least one matched input information as the contact name.

11. The device according to claim 9, wherein the search module is further configured to, after obtaining the basic contact information stored in the local database:
receive an additional information search request from the user for viewing additional contact information corresponding to the contact name;
search the local database to determine whether the additional contact information is stored in the local database; and
provide, when the additional contact information is stored in the local database, the additional contact information to the user.

12. The device according to claim 11, wherein the search module is further configured to:
search, if the additional contact information is not found in the local database, the database server to determine whether the additional contact information is stored in the database server; and
when the additional contact information is stored in the database server:
provide the additional contact information to the user; and
store the obtained additional contact information in the local database.

13. The device according to claim 9, wherein the search module is further configured to, after obtaining the basic contact information from the database server on the network:
receive an additional information search request from the user for viewing additional contact information corresponding to the contact name;
search the database server to determine whether the additional contact information is stored in the database server; and
when the additional contact information is stored in the database server:
provide the additional contact information to the user; and
store the obtained additional contact information in the local database.

14. The device according to claim 9, wherein the search module is further configured to, when the basic contact information is not stored in either the local database or the database server:
obtain the basic contact information entered by the user through the dialing interface; and
store the obtained basic contact information in the local database.

15. The device according to claim 9, further comprising:
an updating module, configured to:
connect to the database server according to a predetermined update cycle, and
update contact information in the local database according to contact information stored in the database server.

16. A database server comprising:
a receiving module, configured to receive a request from a terminal device for obtaining basic contact information corresponding to a contact name entered through a dialing interface on the terminal device; and
a supplying module, configured to provide the basic contact information stored in the database server to the terminal device.

17. The database server according to claim 16, wherein:
the receiving module is further configured to receive a request from the terminal device for obtaining additional contact information corresponding to the contact name, and
the supplying module is further configured to provide the additional contact information stored in the database server to the terminal device.

18. The database server according to claim 16, wherein:
the receiving module is further configured to receive a request from the terminal device for updating contact information in a local database of the terminal device; and
the supplying module is further configured to update the contact information in the local database of the terminal device according to contact information stored in the database server.
